(19) United States
(12) Patent Application Publication
(10) Pub. No.: US 2015/0061163 A1
(43) Pub. Date: Mar. 5, 2015

(54) CARBURETOR

(71) Applicant: KEIHIN CORPORATION, Tokyo (JP)

(72) Inventor: Akira Akabane, Shioya-gun (JP)

(73) Assignee: KEIHIN CORPORATION, Tokyo (JP)

(21) Appl. No.: 14/472,927

(22) Filed: Aug. 29, 2014

(30) Foreign Application Priority Data
Sep. 2, 2013 (JP) 2013-181018

(51) Int. Cl. F02M 37/00

(52) U.S. Cl. CPC F02M 37/0023
USPC 261/36.2

(57) ABSTRACT

A carburetor comprises an intake path, a constant volume fuel chamber and a fuel nozzle. The intake path is connected to an intake port of an engine, and is opened and closed by a throttle valve. The constant volume fuel chamber is provided below the intake path, constantly stores a certain amount of fuel, and has an upper space connected to an air vent. An upper end of the fuel nozzle opens to the intake path to spray fuel of the constant volume fuel chamber to the intake path. The fuel nozzle is connected to a fuel passage communicating to the underneath of a fuel level of the constant volume fuel chamber, and a fuel pump which feeds fuel to the fuel nozzle is interposed in the fuel passage.

### CROSS REFERENCES TO RELATED APPLICATIONS

The present application claims priority under 35 U.S.C. §119 to Japanese Patent Application No. 2013-181018, filed Sep. 2, 2013, entitled “Carburetor.” The contents of this application are incorporated herein by reference in their entirety.

### TECHNICAL FIELD

The present disclosure relates to an improvement of a carburetor. This carburetor comprises an intake path, a constant volume fuel chamber and a fuel nozzle. The intake path is connected to an intake port of an engine, and is opened and closed by a throttle valve. The constant volume fuel chamber is provided below the intake path, constantly stores a certain amount of fuel, and has an upper space connected to an air vent. The upper end of the fuel nozzle opens to the intake path to spray the fuel of the constant volume fuel chamber to the intake path.

### BACKGROUND

In a conventional carburetor, as disclosed in Japanese Unexamined Patent Application Publication No. 7-293342, when the spray amount of the fuel from a fuel nozzle is metered, it depends on a fuel jet disposed below the fuel nozzle and a needle valve which increases the effective opening area of the fuel nozzle according to an increase in the Venturi negative pressure of an intake path. However, to meet the stringent exhaust emission regulations of the engine, there is limitation in the conventional method.

In addition, in the carburetor disclosed in Japanese Unexamined Patent Application Publication No. 2000-303927, a fuel pump for pressurizing the fuel exported from a fuel tank up to 0.8 kg/cm², and a fuel spray valve for metering and supplying the discharged fuel of the fuel pump to the fuel nozzle are included, and the fuel which is metered and supplied to the fuel nozzle is sprayed to the intake path. In such a carburetor, since the connection is established simply by a fuel passage among each of the fuel tank, the fuel pump and the fuel spray valve, in the case that vapor is generated in the fuel passage or the like at high temperature, it is impossible to properly perform the metering and supply of the fuel from the fuel spray valve to the fuel nozzle due to the vapor lock. Consequently, it is difficult to meet the exhaust emission regulations. In addition, since the relatively expensive fuel pump and fuel spray valve are required, the cost will inevitably increase.

### SUMMARY

In view of the above problems, it would be preferable to provide an inexpensive carburetor which always properly perform the metering and supply for the fuel of a fuel nozzle, is able to meet the stringent exhaust emission regulations and has a simple structure.

A first aspect of the present disclosure provides a carburetor which comprises an intake path, a constant volume fuel chamber and a fuel nozzle, the intake path being connected to an intake port of an engine and being opened and closed by a throttle valve, the constant volume fuel chamber being provided below the intake path, constantly storing a certain amount of fuel and having an upper space connected to an air vent, and an upper end of the fuel nozzle opening to the intake path to spray fuel of the constant volume fuel chamber to the intake path. The fuel nozzle is connected to a fuel passage communicating to the underneath of a fuel level of the constant volume fuel chamber, and a fuel pump which feeds fuel to the fuel nozzle is interposed in the fuel passage.

Also, in a second aspect, the fuel passage includes an inhalation passage which is connected to the underneath of a fuel level of the constant volume fuel chamber and a discharge passage which is connected to a lower end of the fuel nozzle, the fuel pump includes a pump chamber which connects between the inhalation passage and the discharge passage, a plunger which reciprocates to pressurize or depressurize the pump chamber, an inhalation valve which is provided in the inhalation passage and opens when the pump chamber is depressurized, a discharge valve which is provided in the discharge passage and opens when the pump chamber is pressurized and an electromagnetic actuator which causes the plunger to reciprocate, a reciprocating motion stroke of the plunger is set as a constant, a fuel supply amount to the fuel nozzle is controlled by the number of reciprocating motion of the plunger.

Also, in a third aspect, the number of reciprocating motion of the plunger is controlled according to an operating condition of an engine.

Also, in a fourth aspect, the number of reciprocating motion of the plunger in 1 cycle of an engine is increased according to an increase in engine load.

Also, in a fifth aspect, a hollow portion which communicates to the underneath of a fuel level of the constant volume fuel chamber is provided in a fixed core and a movable core of the electromagnetic actuator.

According to the first aspect, the vapor generated in the stored fuel of the constant volume fuel chamber floats upward to the upper space of the constant volume fuel chamber, and is discharged to the outside through the air vent, so that the constant volume fuel chamber acts as a gas-liquid separation chamber. Thus, a high quality fuel containing no vapor can be conserved without resorting to a special gas-liquid separation chamber. Since the fuel pump inhales such a high quality fuel, vapor lock does not occur, and hence a predetermined amount of fuel is properly metered and supplied to the fuel nozzle, and this fuel is sprayed to the intake path. Thus, it helps to meet the exhaust emission regulations and reduce the fuel consumption. Besides, since a fuel spray valve is not used in the fuel supply to the fuel nozzle, the structure is simple, thus reducing the cost.

According to the second aspect, it is possible to properly determine the fuel supply amount to the fuel nozzle by the number of reciprocating motion of the plunger.

According to the third aspect, by controlling the number of reciprocation of the plunger according to the operating condition of the engine, it is possible to control the fuel supply amount to the fuel nozzle, that is, the fuel spray amount to the intake path, simply according to the operating condition, and it is always possible to achieve an appropriate air-fuel ratio of the mixture.

According to the fourth aspect, the number of reciprocating motion of the plunger in 1 cycle of the engine is increased according to an increase in the engine load, and thus it is possible to increase the fuel supply amount to the fuel nozzle, that is, the fuel spray amount to the intake path, in 1 cycle of the engine, according to an increase in the engine load, and it is possible to improve the output performance of the engine.

According to the fifth aspect, by filling the hollow portion of the fixed core and the movable core with the fuel of the constant volume fuel chamber, it is possible to cool the fixed core and the movable core, and further to cool the entire electromagnetic actuator.

### BRIEF DESCRIPTION OF THE DRAWINGS

FIG. 1 is a perspective view of a cross-section of a carburetor according to an embodiment of the present application.

FIG. 2 is an enlarged side view of the main part of FIG. 1.

FIG. 3 is a sectional view taken along Line 3-3 of FIG. 1.

FIG. 4 is a fuel flow characteristic curve chart of the carburetor.

### DESCRIPTION OF THE EMBODIMENTS

The embodiments of the present application will be described below with reference to the accompanying drawings.

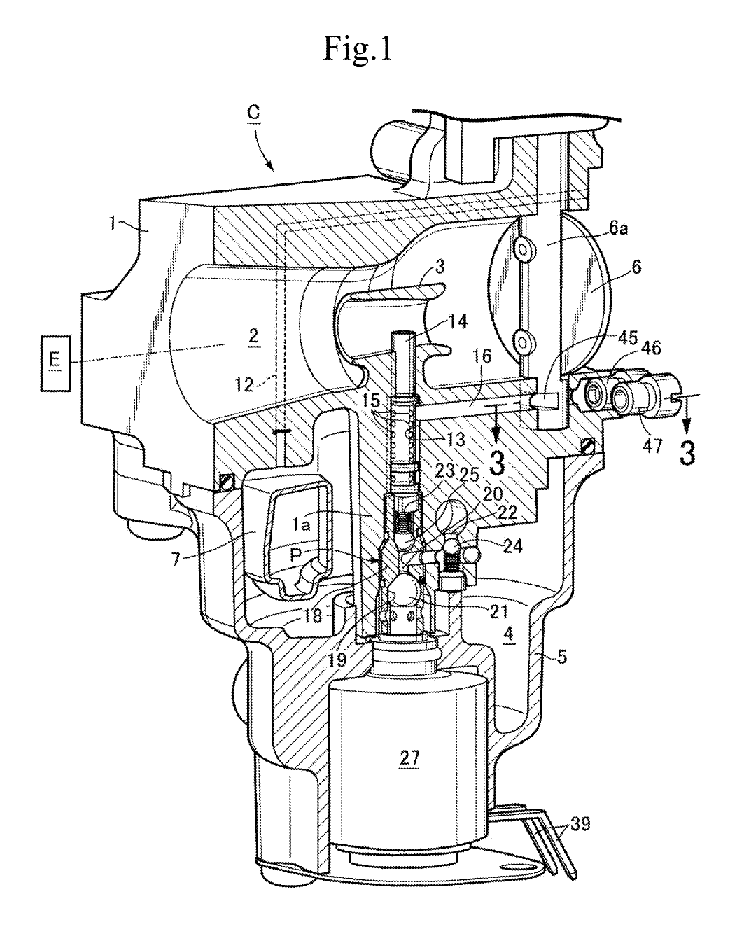

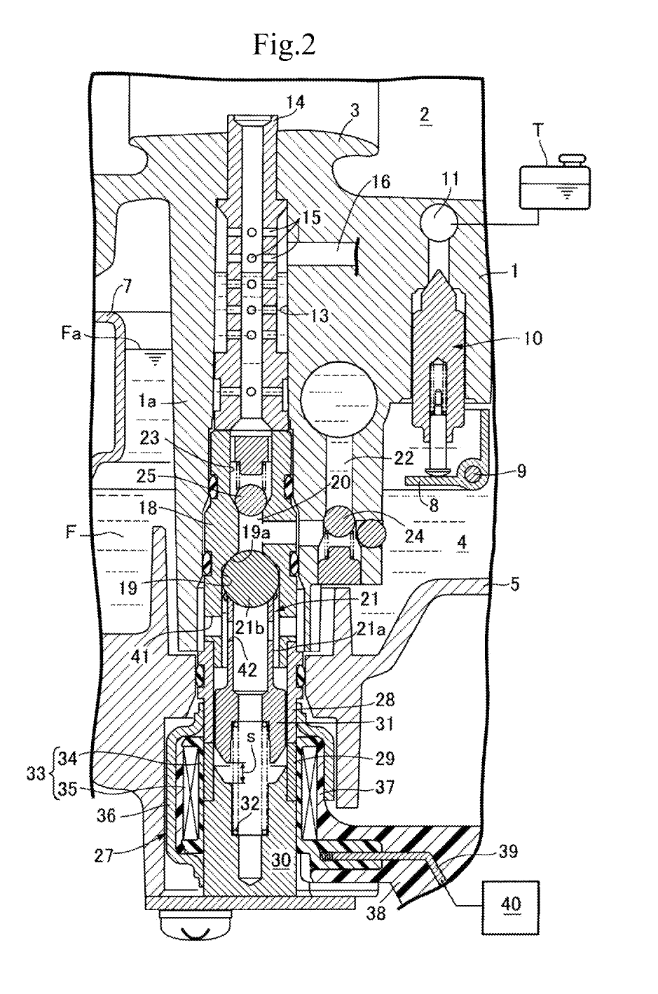

First, in FIG. 1 and FIG. 2, a carburetor C is used for a single-cylinder engine, or is provided for each cylinder of a multi-cylinder engine. The carburetor C includes a carburetor body 1 having an intake path 2 in the horizontal direction connected to an intake port of an engine E, and a float room body 5 which is hermetically engaged to the lower end face of the carburetor body 1 and defines a float room 4 therebetween. The float room body 5 is fastened detachably to the carburetor body 1 by means of bolts.

In the intake path 2, a Venturi tube 3 is disposed in the central portion thereof. Further, a throttle valve 6 of a butterfly valve type is disposed in the upstream portion of the Venturi tube 3.

The carburetor body 1 has integrally a fuel boss 1a which projects to the float room 4 from the lower central portion of the carburetor body 1. A float 7 surrounding this fuel boss 1a is housed in the float room 4. A support plate 8 fixed to one end of this float 7 is vertically swingably supported by the float room body 5 via a pivot 9. The float plate 8 is connected with a float valve 10 which opens and closes a fuel inflow hole 11 of the carburetor body 1 by the vertical swing of the support plate 8. The fuel within the fuel tank T can naturally flow into the fuel inflow hole 11.

Thus, the float 7 makes the float valve 10 close in the horizontal position thereof, and makes the float valve 10 open when falling below the horizontal position thereof. By opening and closing of the fuel inflow hole 11 by the float valve 10 as described above, the fuel F which forms a fuel level Fa of a certain constant level is constantly stored in the float room 4. In the upper space of the float room 4, the intake path 2 upstream is made communicating by the throttle valve 6 via an air vent 12.

A cylindrical fuel well 13 formed in the upper portion of said fuel boss 1a. A hollow cylindrical fuel nozzle 14 which penetrates the central portion of the fuel well 13 and opens inside the Venturi tube 3, is fitted to the fuel boss 1a. A plurality of bleed holes 15 which open to the fuel well 13 are drilled and provided on this fuel nozzle 14. In addition, the fuel well 13 is connected with an air bleed 16 which opens to the intake path 2 upstream through the throttle valve 6. This air bleed 16 will be described in detail later.

In addition, a reciprocating-type fuel pump P which pumps the fuel F of the float room 4 up to the fuel well 13 is mounted to the fuel boss 1a. As clearly shown in FIG. 2, this fuel pump P includes a cylinder body 18 which is fitted in the fuel boss 1a and abuts against the lower end of the fuel nozzle 14. A cylinder hole 19 and a pump chamber 20 connected with the upper end of the cylinder hole 19 are disposed in this cylinder body 18, and a plunger 21 is provided in the cylinder hole 19. The plunger 21 comprises a hollow cylindrical plunger body 21a and a spherical plunger tip 21b which is welded to the upper end of the plunger body 21a and is slidably fitted in the cylinder hole 19. The pressurizing and depressurizing of the pump chamber 20 are repeated by the rise and fall of this plunger 21. The rising motion of the plunger 21 is limited by an upper end surface 19a, which is connected with the pump chamber 20, of the cylinder hole 19.

The pump chamber 20 communicates to the underneath of the fuel level Fa of the float room 4 via an inhalation passage 22 in which an inhalation valve 24 that opens when the pump chamber 20 is depressurized is interposed. In addition, the pump chamber 20 communicates to the fuel well 13 and fuel nozzle 14 via a discharge passage 23 in which a discharge valve 25 that opens when the pump chamber 20 is pressurized is interposed.

The lower end of said plunger is connected to an electromagnetic actuator 27. The electromagnetic actuator 27 includes a magnetic cylindrical body 28 which is connected by being fitted to the lower end of the cylinder body 18, a non-magnetic cylindrical body 29 which is engaged to the lower end of the magnetic cylindrical body 28, a fixed core 30 which is fixed by being fitted to the lower inner peripheral surface of the non-magnetic cylindrical body 29, a movable core 31 which is integrally connected and provided to the lower end of the plunger body 21a and is slidably fitted on the inner peripheral surface of the magnetic cylindrical body 28 to face the upper end surface of the fixed core 30, a return spring 32 which is mounted under compression between the fixed core 30 and the movable core 31 and presses upward the movable core 3, a coil assembly 33 which extends over the non-magnetic cylindrical body 29 and the fixed core 30 and is disposed on the outer periphery thereof, and a coil housing 36 of magnetic material which surrounds the coil assembly 33 and of which the upper and lower ends are engaged with the non-magnetic cylinder 29 and the fixed core 30, respectively. The magnetic cylindrical body 28 is disposed to liquid-tightly penetrate to the bottom of said float room body 5.

The coil assembly 33 consists of a bobbin 34 which is fitted on the outer peripheries of the non-magnetic cylindrical body 29 and the fixed core 30, a coil 35 which is wound around the bobbin 34, and a covering body 37 which is made of a synthetic resin covering the coil 35. In a coupler 38 which is connected and provided integrally with this covering body 37, a power supply terminal 39 connected to the coil 35 is held. This power supply terminal 39 is connected with an electronic control unit 40 which controls the energization for the coil 35.

The hollow portion of the plunger body 21a communicates to the underneath of the fuel level Fa of the float room 4 via a first through hole 41 of the cylinder body 18 and a second through hole 42 of the plunger body 21a. In addition, the hollow portion of the plunger body 21a communicates to the bottomed hollow portion of the fixed core 30 via the penetrated hollow portion of the movable core 31. As a result, the respective hollow portions of the plunger body 21a, the movable core 31 and the fixed core 30 are constantly filled by the fuel of the float room 4, thus not interfering with the rise and fall of the movable core 31 and the plunger 21. Further, the fuel F filling the hollow portion is interchanged with the fuel F of the float room 4 according to the rise and fall of the movable core 31 and the plunger 21, thus contributing to the cooling of the movable core 31 and the fixed core 30.

In addition, the interiors of the magnetic cylindrical body 28 and the non-magnetic cylindrical body 29 communicates with the first through hole 41, thus being constantly filled with the fuel F of the float room 4. This fuel as a lubricant facilitates the reciprocating sliding of the movable core 31.

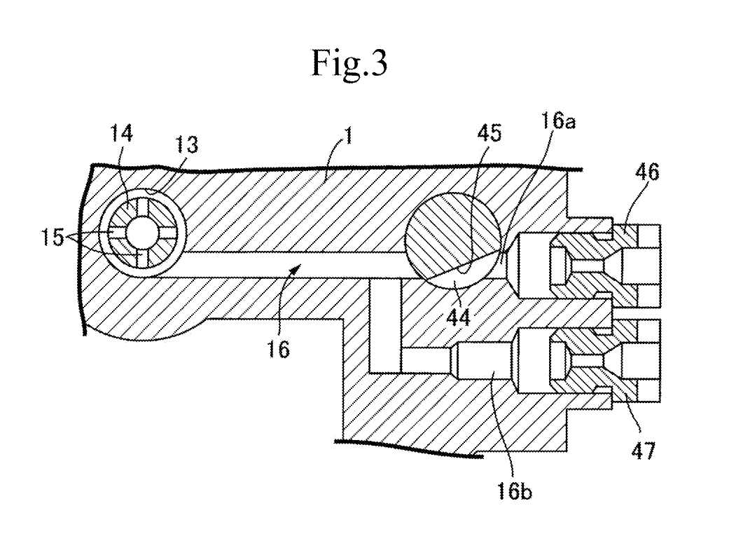

As shown in FIG. 3, the upstream portion of said air bleed 16 is bifurcated into a fist branch passage 16a and a second branch passage 16b. A first fixed air jet 46 and a variable air jet 45 are provided in series on the first branch passage 16a. A second fixed air jet 47 is provided on the second branch passage 16b.

A notch 44 is provided on a part rotatably supported by the carburetor body 1, of a valve shaft 6a of the throttle valve 6. The variable air jet 45 is formed by the bottom surface of this notch 44. This variable air jet 45 is interposed in series with the first fixed air jet 46, in the first branch passage 16a. In addition, the variable air jet 45 opens the fist branch passage 16a according to an increase in the opening degree of the throttle valve 6.

Next, the operation of the present embodiment will be described.

After energizing the coil 35, by the magnetic force generated between the fixed core 30 and the movable core 31, the moveable core 31 is attracted by fixed core 30 against the pressing of the return spring 32. Along with this, the plunger 21 falls down, thus depressurizing the pump chamber 20. Therefore, the inhalation valve 24 is opened while the closing of the discharge valve 25 is maintained, and the fuel F of the float room 4 is inhaled into the pump chamber 20 through the inhalation passage 22. Next, the energization for the coil 35 is cut off Subsequently, by the pressing force of the return spring 32, the movable core 31 and the plunger 21 rises up to the ceiling which abuts against the upper end surface 19a of the cylinder hole 19, thus pressurizing the pump chamber 20. Therefore, the discharge valve 25 is opened while the inhalation valve 24 is closed, and a certain amount of fuel F is pumped up into the fuel well 13 from the pump chamber 20 through the discharge passage 23.

Thus, when the plunger 21 is at the ceiling, a gap s between the fixed core 30 and the movable core 31 is the reciprocating stroke of the plunger 21. Since this reciprocating stroke is constant, this fuel pump P is a constant volume pump. In this way, the total pumping-up amount, that is, the charge amount, of the fuel F to the fuel well 13 is determined by the number of operations of the fuel pump P (the number of reciprocating motion of the plunger 21).

During 1 cycle of the engine E, such charge of the fuel F to the fuel well 13 is performed prior to the intake stroke. After the start of the intake stroke, by the action of the intake air flowing through the intake path 2, along with the bleed air flowing into the fuel well 13 through the air bleed 16, the fuel F of the fuel well 13 is sprayed while being atomized by the Venturi tube 3, and turns into a mixture having a desired air-fuel ratio so as to be inhaled by the engine E. Thus, by freely controlling the air-fuel ratio of the mixture, it is possible not only to easily meet the stringent exhaust emission regulations of the engine E, but also to improve the fuel efficiency.

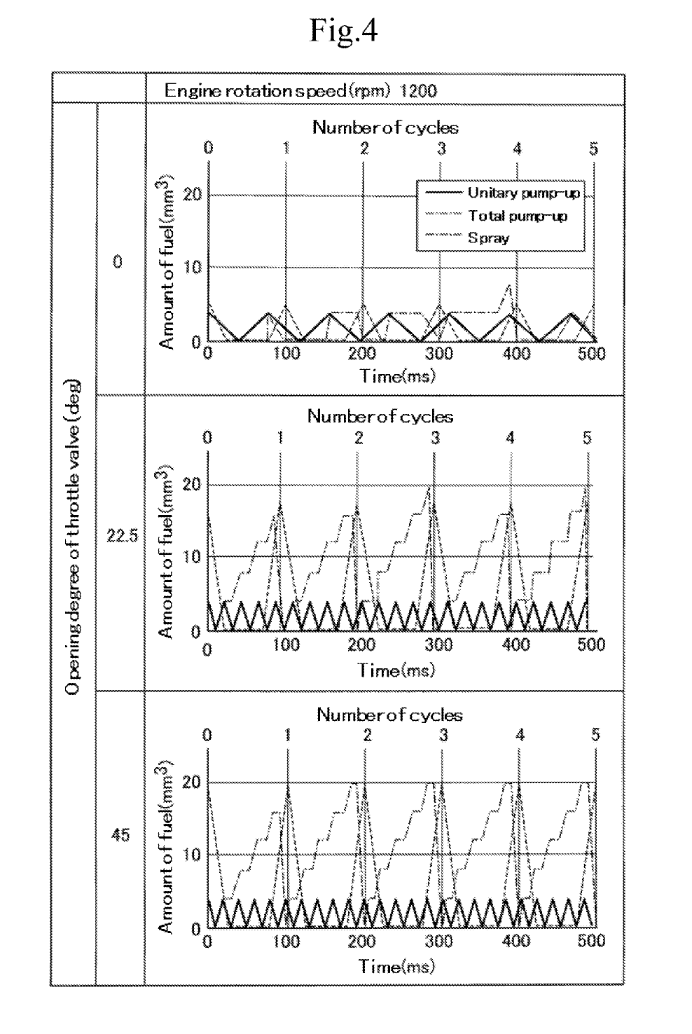

Moreover, as shown in FIG. 4, the fuel pump P is controlled by the electronic control unit 40, so as to increase the number of operations of the fuel pump P during 1 cycle according to an increase in the opening degree of the throttle valve 6, that is, the engine load. Thus, the charge amount of the fuel F to the fuel well 13 is increased with an increase of the engine load, so that it is possible to improve the output performance of the engine E.

The vapor generated in the stored fuel F of the float room 4 floats upward to the upper space of the float room 4, and is released to the upstream portion of the intake path 2 through the air vent 12. That is, the function of a gas-liquid separation chamber is realized by the float room 4. Thus, it is possible to conserve the high quality fuel F containing no vapor without resorting to a special gas-liquid separation chamber. Since the fuel pump P has inhaled such high quality fuel F, vapor lock is not caused, and a predetermined amount of fuel F can be properly metered and pumped up to the fuel well 13 during each operation. It helps to meet the exhaust emission regulations and reduce the fuel consumption.

The flow rate of the bleed air supplied to the fuel well 13 is limited by the first fixed air jet 46, the variable air jet 45 and the second fixed air jet 47 which are provided in the upstream portion of the air bleed 16. That is, at the time of the idle opening of the throttle valve 6, the variable air jet 45 closes the first branch passage 16a, so that the charge amount of the bleed air to the fuel well 13 is limited to a minimum due to being supplied only through the second fixed air jet 47. Since the variable air jet 45 gradually opens the first branch passage 16a with a gradual increase in the opening degree of the throttle valve 6, the supply amount of the bleed air to the fuel well 13 is limited by the variable air jet 45 and the second fixed air jet 47, and gradually increases according to an increase in the opening degree of the throttle valve 6. When the throttle valve 6 has reached a high opening degree, the variable air jet 45 makes the first branch passage 16a fully opened, so that the supply amount of the bleed air to the fuel well 13 is regulated to a maximum by the first fixed air jet 46 and the second fixed air jet 47.

Thus, the supply amount of the bleed air to the fuel well 13 increases according to an increase in the opening degree of the throttle valve 6, and corresponds to an increase in the charge amount of the fuel F to the fuel well 13. As a result, it is possible to appropriately correct the air-fuel ratio of the mixture according to the engine load. It helps to meet the exhaust emission regulations and reduce the fuel consumption.

In addition, the throttle valve 6 is arranged in the intake path 2 which is further in the upstream than the Venturi tube 3 in which the fuel nozzle 14 opens. Therefore, even at the time of the low opening including the idle opening of the throttle valve 6, the intake negative pressure of the engine E reliably acts on the opening portion of the fuel nozzle 14, and promotes the spray of the fuel within the fuel well 13 and the fuel nozzle 14 when this fuel is mixed by the bleed air flowing into the fuel well 13 from the air bleed 16. It is possible to cause all of the charged fuel of the fuel well 13 to be sprayed into the intake path 2 in the intake stroke, and there is no residual fuel in the fuel well 13 after the spray. Therefore, it is possible to prevent the insufficient fuel spray or the excess spray in the next intake stroke caused by the residual fuel in the fuel well 13. Thus, it is always possible to ensure an appropriate fuel spray state, and it helps to meet the exhaust emission regulations and reduce the fuel consumption.

The present invention is not limited to the embodiments described above, and various design changes are possible within the scope not departing from the spirit thereof. For example, the fuel pump P can be configured to be in an inhalation stroke when the electromagnetic actuator 27 is energized, and to be in a discharge stroke when the energization is cut off.

We claim:

1. A carburetor comprising:
an intake path, the intake path being connected to an intake port of an engine and being opened and closed by a throttle valve;
a constant volume fuel chamber, the constant volume fuel chamber being provided below the intake path, constantly storing a certain amount of fuel and having an upper space connected to an air vent; and
a fuel nozzle having an upper end thereof opening to the intake path to spray the fuel of the constant volume fuel chamber to the intake path,
wherein the fuel nozzle is connected to a fuel passage communicating to the constant volume fuel chamber underneath a fuel level of the constant volume fuel chamber, and the carburetor further comprises a fuel pump which is inserted in the fuel passage and feeds the fuel from the constant volume fuel chamber to the fuel nozzle.

2. The carburetor according to claim 1, wherein
the fuel passage includes an inhalation passage which is connected to the constant volume fuel chamber underneath the fuel level and a discharge passage which is connected to a lower end of the fuel nozzle,
wherein the fuel pump comprises:
a pump chamber which connects between the inhalation passage and the discharge passage,
a plunger which reciprocates to pressurize or depressurize the pump chamber,
an inhalation valve which is provided in the inhalation passage and opens when the pump chamber is depressurized,
a discharge valve which is provided in the discharge passage and opens when the pump chamber is pressurized, and
an electromagnetic actuator which causes the plunger to reciprocate,
wherein a reciprocating motion stroke of the plunger is set constant such that a fuel supply amount to the fuel nozzle is controlled by the number of reciprocating motion of the plunger.

3. The carburetor according to claim 2, wherein
the number of reciprocating motion of the plunger is controlled according to an operating condition of the engine.

4. The carburetor according to claim 3, wherein
the number of reciprocating motion of the plunger in one cycle of the engine is increased according to an increase in engine load.

5. The carburetor according to claim 2, wherein
the electromagnetic actuator includes a fixed core and a movable core, and
wherein a hollow portion which communicates to the constant volume fuel chamber underneath the fuel level is provided in the fixed core and the movable core.

6. The carburetor according to claim 5, wherein
the hollow portion provided in the fixed core and the movable core receives the fuel from the constant volume fuel chamber.

7. The carburetor according to claim 1, wherein
the fuel pump is interposed in the fuel passage.
